(19) United States
(12) Patent Application Publication
(10) Pub. No.: US 2006/0274390 A1
(43) Pub. Date: Dec. 7, 2006

(54) Image processing device, image processing method, and image processing program product allowing reproduction of information lost in printing

(75) Inventor: Toshihiko Otake, Nishinomiya-shi (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/226,487

(22) Filed: Sep. 15, 2005

(30) Foreign Application Priority Data
Jun. 7, 2005 (JP) 2005-166837

(51) Int. Cl. H04N 1/40

(52) U.S. Cl. 358/537; 358/448

(57) ABSTRACT

An extraction unit included in an image processing device extracts specific information that may be lost from a document image to be printed. The extracted information is converted into a two-dimensional bar code as additional information at an additional information generation unit. A print unit forms the document image on paper and also adds the additional information generated at the additional information generation unit to the paper. The additional information includes, for example, color information of the document image.

This application is based on Japanese Patent Application No. 2005-166837 filed with the Japan Patent Office on Jun. 7, 2005, the entire content of which is hereby incorporated by reference.

### BACKGROUND OF THE INVENTION

1. Field of the Invention

The present invention relates to an image processing device, an image processing method, and an image processing program product, and particularly to an image processing device, an image processing method, and an image processing program product allowing information lost when printed to be reproduced.

2. Description of the Related Art

Conventionally, image forming devices such as MFP (Multi Function Peripheral) having functions of copiers, facsimiles, and printers perform the following operations.

(1) In monochrome fax systems handling monochrome data, a monochrome image is printed after fax reception.

(2) When image data is to be printed, character information is converted into dot data of a defined size according to a designated magnification factor and is then printed on paper.

(3) When image data is to be printed, character information is converted into dot data in defined colors and is then printed on paper.

In the field of such image forming and image processing, the following documents are known.

Japanese Laid-Open Patent Publication No. 2004-088420 discloses a copying machine reading a code in a predetermined format included in image data and performing image processing based on the read code.

Japanese Laid-Open Patent Publication No. 07-154581 discloses an image forming device comparing and extracting read image data with a prescribed pattern as registered beforehand for converting colors of the extracted image data corresponding to the prescribed pattern.

Japanese Laid-Open Patent Publication No. 2001-260459 discloses a technique for changing character sizes, character pitches, and line feed pitches in order to prevent distortion of characters when printed. Japanese Laid-Open Patent Publication No. 2003-150339 discloses a technique for suspending printing when distortion of characters occurs. Japanese Laid-Open Patent Publication No. 2004-153566 discloses a technique for embedding a place in which data is held by digital watermarking or the like for retrieving and printing the original data during copying processing.

Japanese Laid-Open Patent Publication No. 2001-293926 discloses a technique for adding outlines to graduations of colors and converting a pattern in a pattern region. Japanese Laid-Open Patent Publication No. 2001-257867 discloses a technique for adding a color name indication to a printed image.

When an image is formed on paper based on externally-received image data or read image data, the image formed on the paper often has information lost from original image data depending on the conditions for forming an image (the magnification factor of the image or the performance of the machine itself).

This takes place, for example, in the following manners.

(1) In monochrome faxes handling monochrome data, color information of an original image is lost and the received image is printed in monochrome.

(2) When the size of characters written in a document is small or when a character size is decreased due to 2 in 1 or 4 in 1 printing, the characters are distorted in printed matter, resulting in illegible text.

(3) When characters are printed in colors unrecognizable for people with color vision deficiency or when the color of the background is similar to the color of characters, the text in printed matter is sometimes unreadable.

### SUMMARY OF THE INVENTION

The present invention is made to solve the aforementioned problems and aims to provide an image processing device, an image processing method, and an image processing program product allowing reproducibility of images to improve.

In order to achieve the aforementioned purpose, in accordance with one aspect of the present invention, an image processing device includes: an extractor extracting information lost when an image is printed, from the image; an additional information generator generating additional information based on the information extracted at the extractor; and an adder rendering the additional information generated at the additional information generator as information to be added to the image.

In accordance with another aspect of the present invention, an image processing device includes: an additional information reader reading, from paper having an image formed thereon, additional information added to the paper that is generated based on information lost from an image when printed; and a display displaying the read additional information.

In accordance with a further aspect of the present invention, an image processing device includes: an additional information reader reading, from paper having an image formed thereon, additional information added to the paper that is generated based on information lost from an image when printed; an editor editing the image on the paper based on the additional information read at the additional information reader; and an image former printing the image edited by the editor on paper.

In accordance with a still further aspect of the present invention, an image processing method includes: an extraction step of extracting information lost when an image is printed, from the image; an additional information generation step of generating additional information based on the information extracted at the extraction step; and an addition step of rendering the additional information generated at the additional information generation step as information to be added to the image.

In accordance with yet another aspect of the present invention, an image processing method includes: an additional information reading step of reading, from paper having an image formed thereon, additional information added to the paper that is generated based on information lost from the image when printed; an editing step of editing the image on the paper based on the additional information read at the additional information reading step; and an image forming step of printing the image edited through the editing step on paper.

In accordance with another aspect of the present invention, an image processing program product causes a computer to execute: an extraction step of extracting information lost when an image is printed, from the image; an additional information generation step of generating additional information based on the information extracted at the extraction step; and an addition step of rendering the additional information generated at the additional information generation step as information to be added to the image.

In accordance with still another aspect of the present invention, an image processing program product causes a computer to execute: an additional information reading step of reading, from paper having an image formed thereon, additional information added to the paper that is generated based on information lost from the image when printed; an editing step of editing the image on the paper based on the additional information read at the additional information reading step; and an image forming step of printing the image edited through the editing step on paper.

In accordance with the present invention, information lost when an image is printed is extracted, additional information is generated based on the extracted information, and the generated additional information is rendered as information to be added to the image. Therefore, an image processing device, an image processing method, and an image processing program product can be provided which allow reproducibility of images to improve.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a hardware configuration of an image forming device in accordance with a first embodiment of the present invention.

FIG. 2 is a block diagram showing a functional configuration of the image forming device in accordance with the first embodiment.

FIG. 3 is a flowchart showing an operational sequence of an image forming device 110 in accordance with the first embodiment.

FIG. 4 is a conceptual diagram showing a system employing the image forming device in accordance with the first embodiment.

FIG. 5 is a block diagram showing a functional configuration of an image forming device in accordance with a second embodiment.

FIG. 6 is a block diagram in which an image processing device is configured with a mobile phone with a camera.

FIG. 7 is a block diagram in which an image processing device is configured with a display device including a personal computer.

FIG. 8 is a flowchart showing an operational sequence of an image forming device 210 in accordance with a second embodiment.

FIG. 9 is a conceptual diagram showing a system employing an image forming device in accordance with the second embodiment.

### DESCRIPTION OF THE PREFERRED EMBODIMENTS

In the following, an image processing device, an image forming device, and the like in accordance with the embodiments of the present invention will be described.

An extractor included in an image forming device extracts specific information that may be lost from a document image to be printed. The extracted information is converted as additional information at an additional information generator. A printer forms the document image on paper and also adds the additional information generated at the additional information generator in an adder.

It is noted that the following three cases are assumed as the information extracted from a document image and converted into additional information.

In accordance with a first embodiment, the additional information is color information of a document image. When printed matter with color information added as additional information is transmitted by a monochrome fax which only handles monochrome images, an image reader in an image forming device receiving a monochrome image extracts the additional information at an additional information reader. An editor in the image forming device converts the monochrome image into a color image based on the read additional information and prints the color image subjected to color conversion in an image former.

In accordance with a second embodiment, the additional information is text information having a character size smaller than a size as registered beforehand. An additional information reader in an image processing device reads the additional information in printed matter and displays the text information read by the additional information reader at a display.

In accordance with the second embodiment, the additional information further refers to text information written in a color as registered beforehand. An additional information reader in an image processing device reads the additional information in printed matter and displays the text information read by the additional information reader at a display.

In the following, the embodiments of the present invention will be described.

### First Embodiment

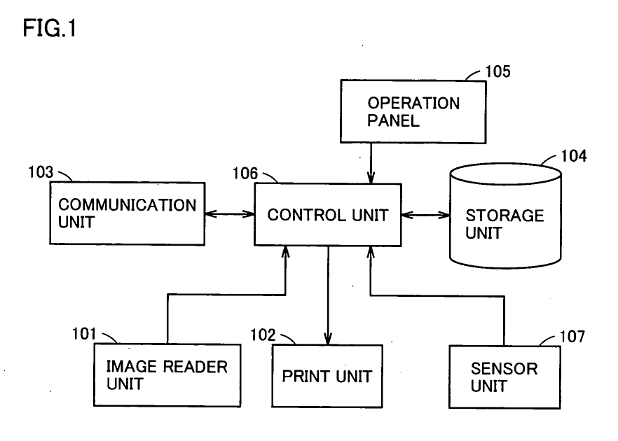

FIG. 1 is a block diagram showing a hardware configuration of an image forming device in accordance with a first embodiment of the present invention.

Referring to FIG. 1, an image forming device includes a control unit 106 controlling the entire device, an image reader unit 101 reading image data from a document in color, a print unit 102 printing an image on paper, a communication unit 103 for performing radio communications at close range and connecting a printer to a network or a telephone line, a storage unit 104 for storing job data and the like, an operation panel 105 serving as an interface with users, and a sensor unit 107 detecting the remaining amount of consumables, and the like.

The image forming device in accordance with the present embodiment is configured to allow a color image to be printed, even for use in an existing monochrome fax system (not employing a color fax system).

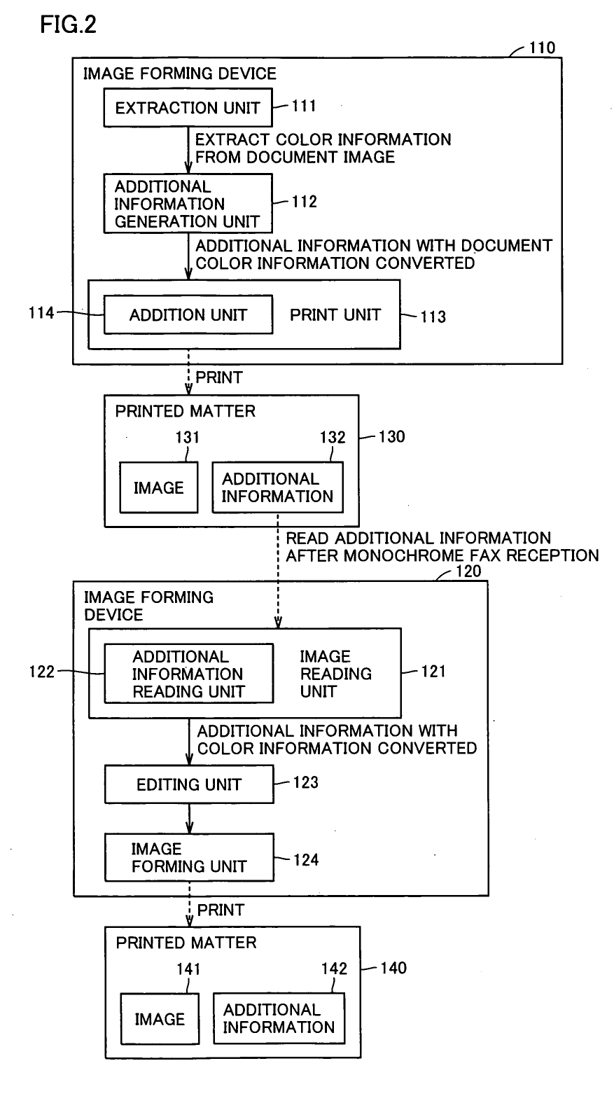

FIG. 2 is a block diagram showing a functional configuration of an image forming device in accordance with the present embodiment.

Here, image data is communicated via fax communications between two image forming devices 110 and 120. In communications, only monochrome image data is transmitted.

An image forming device 110 includes an extraction unit 111, an additional information generation unit 112, and a print unit 113. Extraction unit 111 extracts color information from document image data. The color information includes, for example, a coordinate point of a start point, the number of pixels in the horizontal direction, the number of pixels in the vertical direction, and a code indicative of the color in the region. Additional information generation unit 112 converts the color information extracted by extraction unit 111 into additional information such as a two-dimensional bar code.

Print unit 113 prints the document image and also prints the additional information generated by additional information generation unit 112 at an addition unit 114. A document image 131 and additional information 132 with the color information converted are thereby printed on printed matter 130.

Here, it is assumed that printed matter 130 is transmitted via fax in the existing monochrome fax standard which handles monochrome data only. Printed matter 130 is scanned and sent through a telephone line. Since the data sent through the telephone line is monochrome data, the image data received at image forming device 120 is also monochrome data, as a matter of course.

Image forming device 120 includes an image reading unit 121, an additional information reading unit 122, an editing unit 123, and an image forming unit 124. Image reading unit 121 receives monochrome image data through a fax line and also extracts additional information such as a two-dimensional bar code at additional information reading unit 122.

Editing unit 123 performs color conversion of the received monochrome image data into a color image based on the color information that is the additional information extracted at additional information reading unit 122. Image forming unit 124 prints the color image subjected to color conversion at editing unit 123. An image 141 in printed matter 140 is the original color image.

It is noted that although here additional information 132 of which image is formed on paper together with document image 131 is a two-dimensional bar code by way of example, the color information may be converted and printed in a one-dimensional bar code, a pattern image, a watermark, and the like.

Although here additional information is directly extracted at additional information reading unit 122 with respect to monochrome image data received through a fax line by way of example, printed matter, which is once printed in monochrome images, may be read again by a scanner and additional information may be extracted from the read image for conversion into color images.

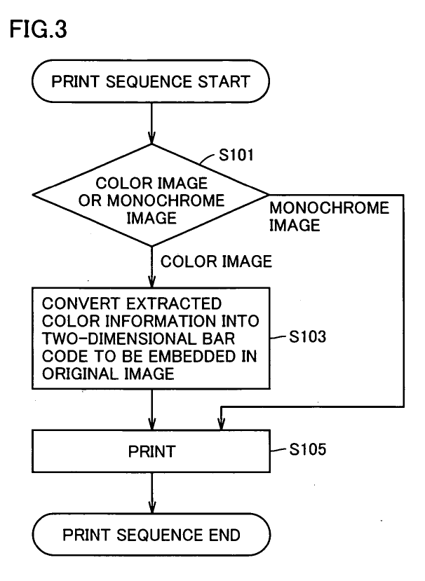

FIG. 3 is a flowchart showing an operational sequence of image forming device 110 in accordance with the present embodiment.

Referring to FIG. 3, it is determined at step S101 whether image data read at image reader unit 101 or input image data is formed of a color image or a monochrome image. If it is determined as a color image, color information extracted at step S103 is converted into a two-dimensional bar code and embedded in an original image for printing at step S105.

On the other hand, if it is determined as a monochrome image at step S101, the process continues to step S105.

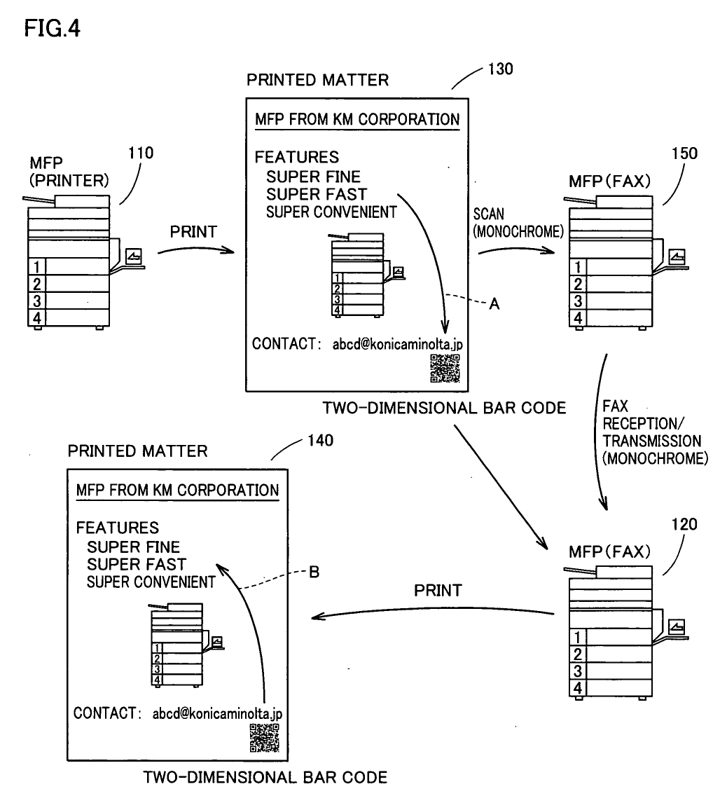

FIG. 4 is a conceptual diagram showing a system employing the image forming device in accordance with the present embodiment.

Referring to FIG. 4, the system is configured with an image forming device 150 in addition to image forming device 110 and image forming device 120 shown in FIG. 2. Here, the image forming device is an MFP.

When a color document is printed by image forming device 110, printed matter 130 is printed in monochrome and information about the color in the image is printed as a two-dimensional bar code in a corner of the printed matter as shown by A in the figure. Alternatively, modes such as a monochrome fax printing mode and a color copy mode can be set in image forming device 110, so that the aforementioned printed matter 130 may be output only when the former is selected, and normal color copying may be performed when the latter is selected.

When image forming device 150 having a monochrome fax function reads printed matter 130 as monochrome data and faxes the same to image forming device 120 in monochrome, image forming device 120 reproduces color information based on the two-dimensional bar code as additional information and converts the monochrome data into color data for printing the image as shown by B in the figure.

It is noted that although here image data is once printed as printed matter 130, which is then read for fax transmission, the image data may be directly transmitted to image forming device 120 without being printed as printed matter 130.

### Second Embodiment

A hardware configuration of an image forming device in accordance with a second embodiment is the same as shown in FIG. 1, and therefore the description will not be repeated herein.

In the present embodiment, the device is configured to allow even text including distorted characters to be readable without disturbing a document image in printed matter (in other words, without changing the magnification factor of the size of characters and a character spacing in an original image).

In addition, in accordance with the present embodiment, the device is configured to allow text written in a specific color to be readable without disturbing a document image in printed matter (in other words, without changing the color of characters or adding frame fines to characters). Specifically, the device is configured such that printed matter can be recognized by even a certain specific person (for example, a person with partial color-blindness or amblyopia).

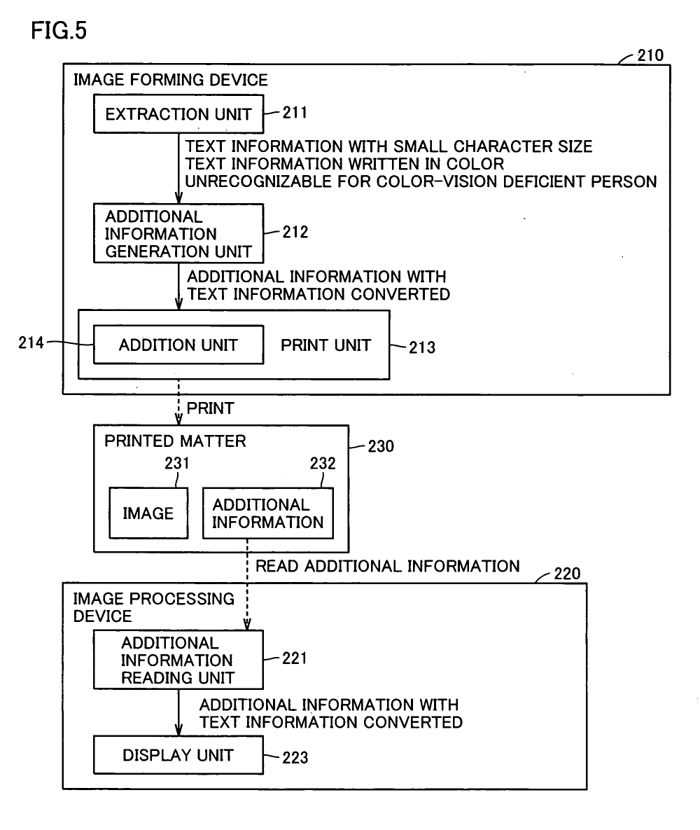

FIG. 5 is a block diagram showing a functional configuration of an image forming device in accordance with the second embodiment.

Referring to FIG. 5, an image forming device 210 includes an extraction unit 211, an additional information generation unit 212, a print unit 213, and an addition unit 214. Extraction unit 211 extracts text with a character size smaller than that registered beforehand or text written in a color as registered beforehand, from document image data.

A character size as registered beforehand refers to the size of a character actually printed according to a magnification factor of printing, which size is defined to cause distortion of characters when printed. It is noted that when the user has difficulty in reading small characters due to presbyopia or the like, a character size larger than the character size that may cause distortion of characters may be registered.

A color as registered beforehand refers to a color that is hardly recognizable when printed assuming that a character color is close to a background color. When the user cannot recognize a specific color due to deficiency of color vision such as partial color-blindness or amblyopia, that unrecognizable color may be registered irrespective of a background.

Additional information generation unit 212 converts text information extracted at extraction unit 211 into additional information such as a two-dimensional bar code. Print unit 213 prints a document image and also prints the additional information generated at additional information generation unit 212.

Therefore, document image 231 and additional information 232 with text information converted are printed on printed matter 230.

Here, it is assumed that printed matter 230 includes text that cannot be recognized by the user since distortion of characters occurs due to a small character size or characters are written in the color unrecognizable for the user.

Here, the user uses an image processing device 220 in reading the contents of printed matter 230.

Image processing device 220 includes an additional information reading unit 221 and a display unit 222. Additional information reading unit 221 reads additional information 232 with text information converted which is printed on printed matter 230. Display unit 222 presents the text information that is the additional information read by additional information reading unit 221. The user understands the text that is illegible in printed matter 230 by reading the text appearing on display unit 222.

It is noted that image processing device 220 as the additional information display device may include a mobile phone with a camera, a digital camera, a dedicated display device, and the like.

It is noted that although here additional information 232 of which image is formed on paper together with document image 231 is a two-dimensional bar code by way of example, text information may be converted and printed in a one-dimensional bar code, a pattern image, a watermark or the like. In addition to forming an image of additional information together with a document image, additional information 232 may be written into an IC tag or a magnetic tape provided on paper.

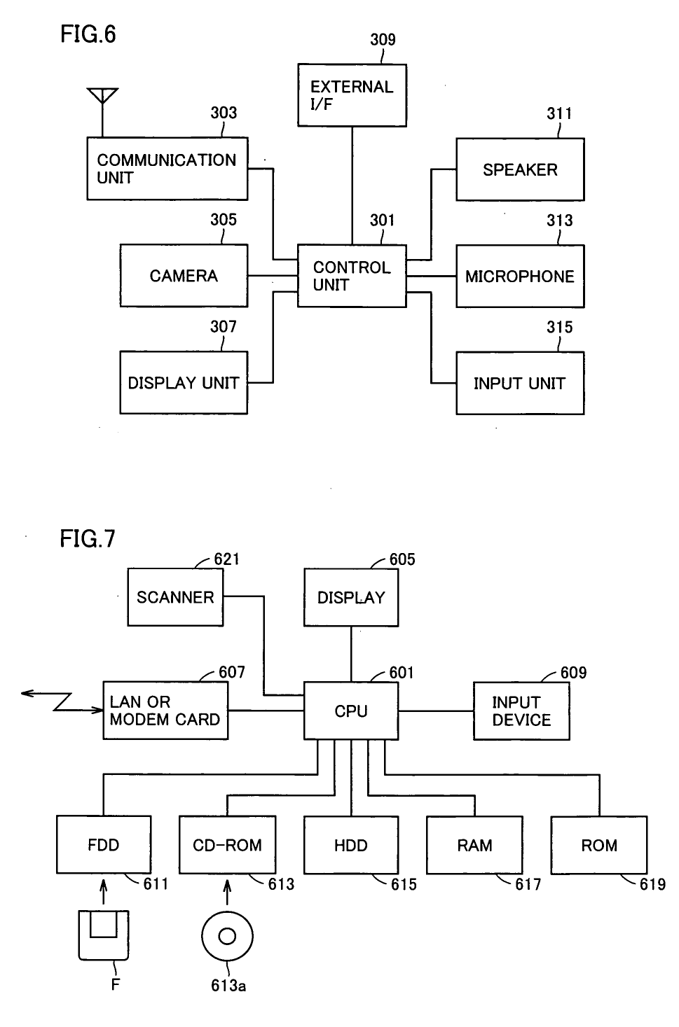

FIG. 6 is a block diagram in which an image processing device is configured with a mobile phone with a camera.

Referring to FIG. 6, the image processing device includes a control unit 301 controlling the entire device, a communication unit 303 performing communications with an external device, a camera 305 picking up an image, a display unit 307 configured with a liquid crystal display device or the like for displaying a document and the like to the user, a speaker 311 outputting voice, a microphone 313 inputting voice, and an input unit 315 formed of a ten-key pad and the like.

FIG. 7 is a block diagram in which an image processing device is configured with a display device including a personal computer.

Referring to FIG. 7, the image processing device includes a CPU (Central Processing Unit) 601 for controlling the entire device, a display 605, an LAN (Local Area Network) card 607 (or a modem card) for connection to a network and communication with an external device, an input device 609 formed of a key board, a mouse, and the like, a flexible disk drive 611, a CD-ROM (Compact-Disk Read Only Memory) drive 613, a hard disk drive 615, an RAM (Random Access Memory) 617, an ROM (Read Only Memory) 619, and a scanner 621 for reading an image.

Flexible disk drive 611 allows data such as a program and an image recorded on a flexible disk F to be read. CD-ROM drive 613 allows data such as a program and an image recorded on a CD-ROM 613a to be read.

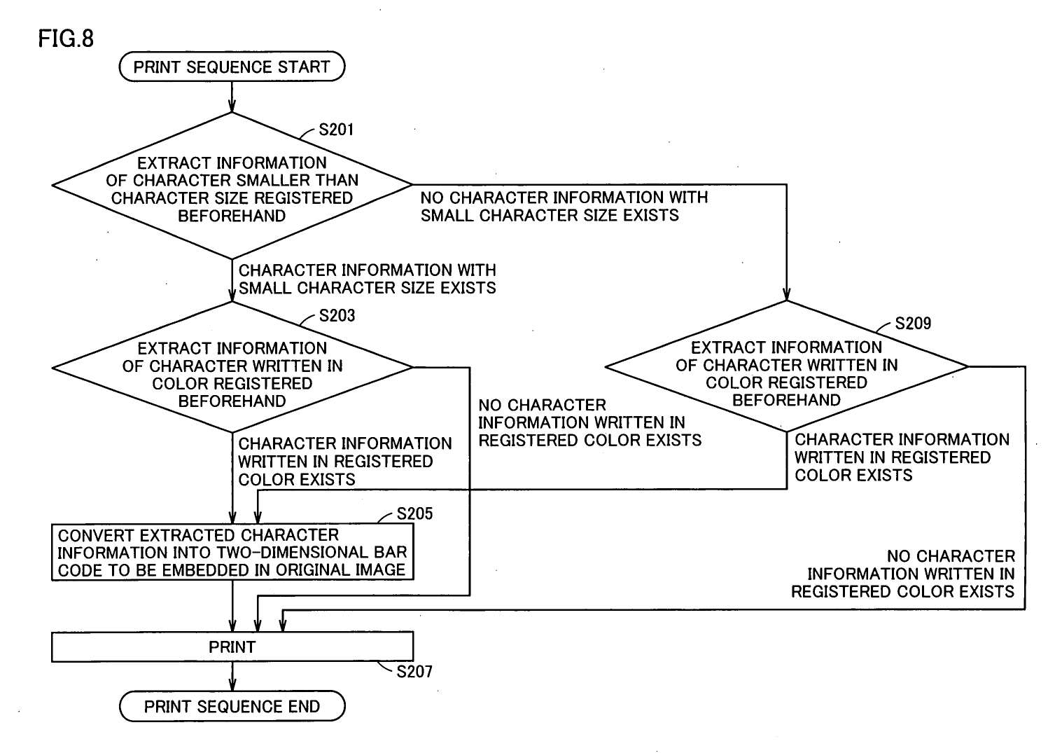

FIG. 8 is a flowchart showing an operational sequence of image forming device 210 in accordance with the present embodiment.

Referring to FIG. 8, it is determined at step S201 whether image data read at image reader unit 101 or input image data includes a character smaller than a character size as registered beforehand for extraction. If a smaller character is included, it is determined at step S203 whether there exists character information written in a color as registered beforehand for extraction. If there exists character information written in a color as registered beforehand, the character information extracted at step S205 is converted into a two-dimensional bar code and embedded in an original image for printing at step S207.

On the other hand, if it is determined at step S203 that there exists no character information written in the registered color, the process continues to step S207.

If it is determined that no small character is included at step S201, it is determined at step S209 whether there exists character information written in a color as registered beforehand for extraction. If there exists character information written in the registered color, the process continues to step S205, and if not, the process continues to step S207.

It is noted that the determination at step S203 may be eliminated and the process may directly go to step S205 if it is determined at step S201 that a small character is included.

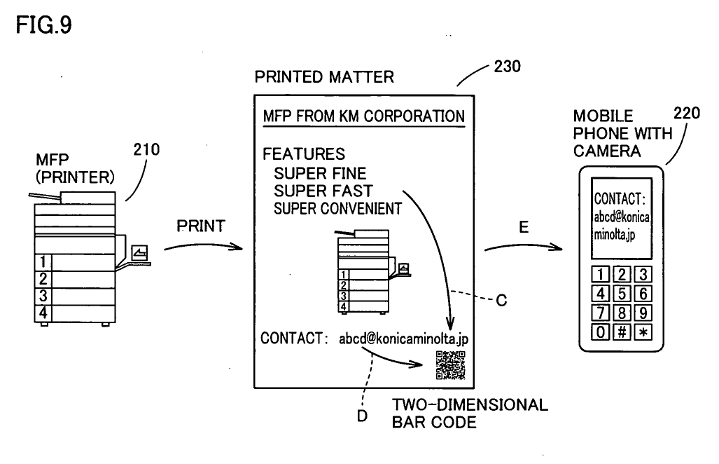

FIG. 9 is a conceptual diagram showing a system employing an image forming device in accordance with the present embodiment.

Referring to FIG. 9, here the system is configured with image forming device 210 and image processing device 220 shown in FIG. 5. Here, the image forming device is an MFP and the image processing device is a mobile phone with a camera.

When a color document is printed by image forming device 210, information about text written in a user-unrecognizable color in printed matter 230 is printed in a corner of the printed matter as a two-dimensional bar code as shown by C in the figure. In addition, information only about that portion which cannot be read (a portion suffering distortion of characters) when printed due to the small character size is also printed as a two-dimensional bar code in a corner of the printed matter as shown by D in the figure.

When the camera of image processing device 220 reads the two-dimensional bar code, the display presents the contents in which the two-dimensional bar code is converted into text data. The user thereby can read the information originally included in printed matter 230.

Alternatively, modes such as a mode of executing the process in the flowchart of FIG. 8 or a color copy mode can be set in image forming device 210, so that the aforementioned printed matter 230 may be output only when the former is selected, and normal color copying may be performed when the latter is selected.

### Effect of the Embodiments

As described above, in accordance with the present embodiments, information lost when printed can be added to and printed on printing paper as additional information so that the information lost from printed matter is readable. Therefore, the convenience of the image forming device such as MFP can be enhanced.

Specifically, the following effects can be achieved in accordance with the present embodiments.

(1) When image data is printed, color information of a document can be converted in a two-dimensional bar code and the like to be printed in a margin. When printed matter is transmitted in accordance with the fax standard only handling monochrome data, a device receiving the fax performs color conversion of a monochrome image to a color image based on the color information of the document extracted from the two-dimensional bar code embedded in the received monochrome image data to allow the same color image as the original document to be reproduced.

(2) When image data is printed, text determined as having a character size too small to be legible can be converted in a two-dimensional bar code or the like to be printed in a margin. When the user reads the two-dimensional bar code using a mobile phone with a camera or the like, the display presents the text converted in the two-dimensional bar code. Therefore, the text having a character size too small to be legible can be read.

(3) When image data is printed, text written in a color undistinguishable for the user due to deficiency of color vision or text difficult to read as being written in a color similar to a background color can be converted in a two-dimensional bar code or the like to be printed in a margin. When the user reads the two-dimensional bar code using a mobile phone with a camera or the like, the display presents the text converted in the two-dimensional bar code to allow the text printed in the unrecognizable color to be read.

### Others

It is noted that the process in accordance with the above embodiments may be performed using software or using a hardware circuit.

Furthermore, a program product executing the process in the forgoing embodiments may be provided. The program may be recorded on a recording media such as a CD-ROM, a flexible disk, a hard disk, an ROM, an RAM, or a memory card and provided to the user. Alternatively, the program may be downloaded to the device via a communication line such as the Internet.

The present invention is applicable to a system connected to a network or to a system not connected to any network environment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing device comprising:
an extractor extracting information lost when an image is printed, from said image;
an additional information generator generating additional information based on the information extracted at said extractor; and
an adder rendering the additional information generated at said additional information generator as information to be added to said image.

2. The image processing device according to claim 1, further comprising a printer performing image forming on paper based on said image, wherein said adder adds said additional information to said paper.

3. The image processing device according to claim 2, wherein said adder performs image forming on said paper based on said additional information using said printer.

4. The image processing device according to claim 1, wherein the information extracted by said extractor is color information in said image.

5. The image processing device according to claim 1, wherein when a character in said image is smaller than a prescribed size, said extractor extracts the character.

6. The image processing device according to claim 1, wherein when a color of a character in said image is a prescribed color, said extractor extracts the character.

7. The image processing device according to claim 1, wherein said additional information is a two-dimensional bar code.

8. An image processing device comprising:
an additional information reader reading, from paper having an image formed thereon, additional information added to the paper that is generated based on information lost from an image when printed;
a display displaying the read additional information.

9. An image processing device comprising:
an additional information reader reading, from paper having an image formed thereon, additional information added to the paper that is generated based on information lost from an image when printed;
an editor editing the image on said paper based on the additional information read at said additional information reader; and
an image former printing the image edited by said editor on paper.

10. The image processing unit according to claim 9, wherein
said additional information is color information in an image, and
said editor performs color conversion of said image based on the information as said additional information.

11. The image processing device according to claim 9, wherein said additional information reader is an image reader reading the image on said paper.

12. An image processing method comprising:
an extraction step of extracting information lost when an image is printed, from said image;
an additional information generation step of generating additional information based on the information extracted at said extraction step; and
an addition step of rendering the additional information generated at said additional information generation step as information to be added to said image.

13. The image processing method according to claim 12, further comprising a print step of performing image forming on paper based on said image, wherein, at said addition step, said additional information is added to said paper.

14. The image processing method according to claim 13, wherein, at said addition step, image forming based on said additional information is performed through said print step on said paper.

15. The image processing method according to claim 12, wherein the information extracted through said extraction step is color information in said image.

16. The image processing method according to claim 12, wherein, at said extraction step, when a character in said image is smaller than a prescribed size, the character is extracted.

17. The image processing method according to claim 12, wherein, at said extraction step, when a color of a character in said image is a prescribed color, the character is extracted.

18. The image processing method according to claim 12, wherein said additional information is a two-dimensional bar code.

19. An image processing method comprising:
an additional information reading step of reading, from paper having an image formed thereon, additional information added to the paper that is generated based on information lost from an image when printed;
a display step of displaying the read additional information.

20. An image processing method comprising:
an additional information reading step of reading, from paper having an image formed thereon, additional information added to the paper that is generated based on information lost from the image when printed;
an editing step of editing the image on said paper based on the additional information read at said additional information reading step; and
an image forming step of printing the image edited through said editing step on paper.

21. The image processing method according to claim 20, wherein
said additional information is color information in an image, and
at said editing step, said image is subjected to color conversion based on the color information as said additional information.

22. The image processing method according to claim 20, wherein said additional information reading step is an image reading step of reading the image on said paper.

23. An image processing program product causing a computer to execute:
an extraction step of extracting information lost when an image is printed, from said image;
an additional information generation step of generating additional information based on the information extracted at said extraction step; and
an addition step of rendering the additional information generated at said additional information generation step as information to be added to said image.

24. An image processing program product causing a computer to execute:
an additional information reading step of reading, from paper having an image formed thereon, additional information added to the paper that is generated based on information lost from the image when printed;
an editing step of editing the image on said paper based on the additional information read at said additional information reading step; and
an image forming step of printing the image edited through said editing step on paper.
